(19) United States
(12) Patent Application Publication
(10) Pub. No.: US 2004/0068575 A1
(43) Pub. Date: Apr. 8, 2004

(54) Method and apparatus for achieving a high transfer rate with TCP protocols by using parallel transfers

(76) Inventor: David Cruise, Loveland, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/263,037

(22) Filed: Oct. 2, 2002

(51) Int. Cl. G06F 15/16

(52) U.S. Cl. 709/232

(57) ABSTRACT

The present invention is directed to a method and apparatus for communicating data across the Internet. Data is first segmented into mutually exclusive groups of information. The data is segmented into mutually exclusive groups by using operating system utilities. Each of the mutually exclusive groups is then communicated in parallel across the Internet. The mutually exclusive groups are communicated in parallel across the internet by spawning processes that each utilize TCP/IP utilities.

### BACKGROUND OF THE INVENTION

1. Field of the Invention

This invention relates to communications. Specifically, the present invention relates to Internet communications.

2. Description of the Related Art

The Internet is a vast connection of computer and communication devices, which are used to transfer information. The information is transferred over various types of interconnected communication media. The information is typically digital information such as data, voice, images or video.

With the incredible increase in the proliferation of the Internet and the large variety of manufacturers and vendors that produce products for the Internet, various standards have developed to facilitate communication across the Internet. One of these standards is the Transmission Control Protocol/Internet Protocol (TCP/IP). The Transmission Control Protocol Internet Protocol (TCP/IP) provides a standardized framework for transmitting information over the Internet. For example, a unit of information transfer known as a packet is defined in the TCP/IP protocol. In addition, the TCP/IP protocol manages the routing of packets from source to destination including the management of any eventualities that may occur. As such, the TCP/IP protocol includes a large variety of management packets and management procedures (e.g., management overhead).

As mentioned previously, the Internet connects many computers. The computers use standardized operating systems. As such, organizational elements within computers, such as units for storing information known as files, directory structures for storing the files, and input/output processes for communicating with peripherals, may be standardized. The computers are connected to the Internet and may use the TCP/IP protocol to communicate information. The standardized TCP/IP protocol as well as standardized or widely used operating systems interface with each other to facilitate the transfer of information across the Internet.

However, as the size of computer files increase, there is a significant increase in the time required to transfer files (e.g., latency) across the Internet. In addition, even when a high-bandwidth connection is used to increase the speed of transferring large files, the cumulative effect of the management overhead of the TCP/IP protocol, causes latencies. The increase in latency is an unwanted problem for many reasons. For example, an increase in latency may discourage the use and the advancement of the Internet.

In addition, any solutions to the problem of latency in the Internet must work within the context of the installed base of technology that is currently implemented in the Internet. For example, since a large installed base of hardware, software and protocols (e.g., TCP/IP) are currently deployed in the Internet, any solution to the problem of latency must function within the context of this installed base of hardware, software and protocols. In addition, since files are transferred from a computer, which also has a standardized or widely deployed environment (e.g., an operating system), any solution to the problem of latency must also work with the standardized environment of the operating system.

Thus, there is a need in the art for a method and apparatus for decreasing the latency of file transfers across the Internet. There is a need in the art for a method and apparatus that decreases Internet latency within the context of the current Internet infrastructure. There is a need in the art for a method and apparatus that decreases Internet latency within the context of standardized computer-operating environments.

### SUMMARY OF THE INVENTION

The present invention is directed to a method and apparatus for reducing file transfer latency across the Internet. A method and apparatus are implemented, which use legacy Internet infrastructure and standardized or widely deployed operating systems.

The method facilitates the transfer of a single large file, multiple large files or directories. In the case of a single large file, the file is segmented into multiple data sets and communicated in parallel streams. In the case of multiple large files, logical data sets that are mutually exclusive are formed and each data set is communicated in a logically parallel stream. In the case of directories, the directories are segmented into multiple data sets and communicated in parallel streams.

Using the method and apparatus of the present invention, latency in the network is substantially decreased. For example, implementing one embodiment of the present invention, the throughput changes from 150 kb/sec when one communication stream is used to 3.5 megabytes/sec when multiple communication streams are used.

A method of transferring data comprises the steps of defining a first dataset and a second dataset using operating system tools, wherein the first data set is mutually exclusive from the second data set; initiating a parent process; and initiating a first child process in response to the parent process and initiating a second child process in response to the parent process, where the first child process communicates the first dataset using Transmission Control Protocol utilities and the second child process communicates the second dataset in parallel with the first data set using the Transmission Control Protocol utilities.

A method of transferring data comprises the steps of defining a plurality of mutually exclusive data sets using operating system tools; initiating a parent process; and initiating a plurality of child processes in response to the parent process where each of the plurality of child processes accesses one of the plurality of mutually exclusive data sets and communicates each of the plurality of mutually exclusive data sets in parallel by using Transmission Control Protocol utilities.

A computer product comprises a computer useable medium and computer readable instructions embodied on the computer readable medium for causing a computer to transfer data in parallel streams, the computer readable instructions cause the compute to, define a plurality of mutually exclusive data sets using operating system tools; initiate a parent process; and initiate a plurality of child processes in response to the parent process where each of the plurality of child processes accesses one of the plurality of mutually exclusive data sets and communicates each of the plurality of mutually exclusive data sets in parallel by using Transmission Control Protocol utilities.

### BRIEF DESCRIPTION OF THE DRAWINGS

FIG. 1 is a flow diagram of a method of the present invention.

FIG. 2 is a block diagram of a multi-purpose computer.

FIG. 3 is a flow diagram illustrating a method of defining datasets.

FIG. 4 is flow diagram illustrating a parent process implemented in accordance with the teachings of the present invention.

FIG. 5 is a flow diagram illustrating a child process implemented in accordance with the teachings of the present invention.

FIG. 6 is a diagram of an architecture implementing a method of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention is directed to a method of reducing file transfer latency across the Internet. In one embodiment of the present invention, latency is reduced by completing parallel transfer of data across the Internet using standardized computer operating system concepts and the TCP/IP protocol. For example, in one method of the present invention, the file structure and directory structure of widely deployed operating systems and a number of TCP/IP utilities are utilized.

It should be appreciated that various operating systems have a large user base and are widely deployed. These operating systems use operating system concepts such as organizing data into file structures and organizing files into directories. Although these operating systems may not be standardized operating systems, because of their wide deployment and use, they may be thought of as standardized operating systems. Therefore, for the purposes of discussion, the widely deployed operating systems will be referred to as standardized operating systems. The present invention may be implemented in any operating system environment in which file structures and directory structures are implemented. In addition, the present invention may be implemented in a computing environment in which file structures or directory structures are implemented.

A variety of computer and operating system concepts are utilized in the method of the present invention. For example, computer files are used as a transfer target. In one embodiment of the present invention, methods are implemented to separate or combine files into data sets, which become the target of the file transfer. In addition, directories (e.g., tree structures) are utilized in the present invention. For example, in another embodiment of the present invention, directories are used to define mutually exclusive data sets for transfer. In addition, sub-directories are also utilized and searched in the method of the present invention. In one embodiment, a directory including files, a sub-directory including files or directories including sub-directories may be the transfer targets.

TCP/IP protocol utilities are used to implement the method of the present invention. TCP/IP protocol utilities provide end users with tools that manage the transfer of information across the Internet. In one embodiment of the present invention, various TCP/IP utilities are used to manage the transfer of data in parallel. Any utility that functions within the TCP/IP protocol suite may be considered a TCP/IP utility. For example, file transfer protocol (FTP) is a common TCP/IP utility, which is used to transfer files within the TCP/IP environment.

In one method of the present invention, scripts are used to interface operating system tools with various TCP/IP utilities to implement the functionality of the present invention. The scripts are computer instructions that direct the operation of a multi-function computer. The scripts communicate with the operating system and invoke the TCP/IP utilities. Once the function of the utility is completed, control returns back to the script. The scripts also provide an interface between the operating system and the TCP/IP protocol. For example, scripts may be launched from within the operating system and invoke a TCP/IP utility from within the operating system.

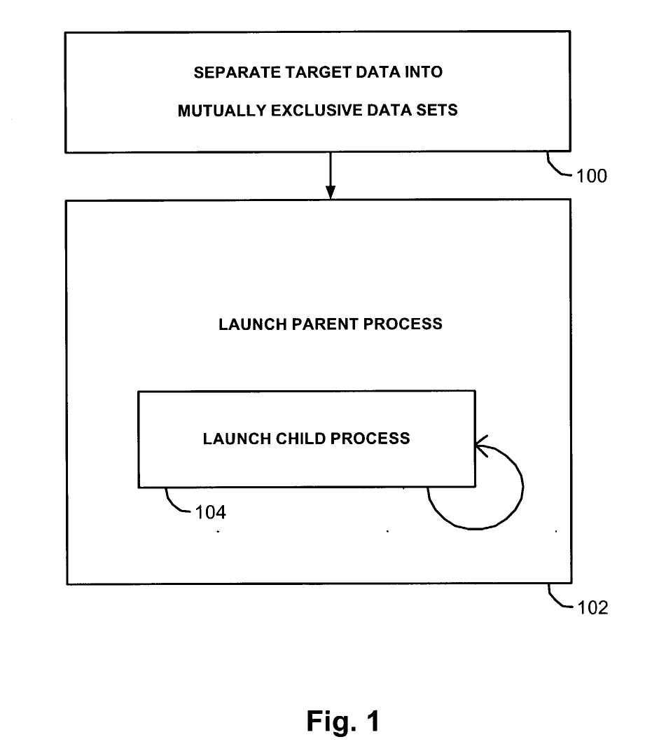

FIG. 1 displays a method implemented in accordance with the teachings of the present invention. In FIG. 1 target data is separated into mutually exclusive data sets as shown at 100. A parent process is run as shown at 102 and child processes are run as shown at 104. In one embodiment of the present invention, the method of the present invention may be implemented as a script. In addition, the method of each step shown in FIG. 1 (e.g., 100, 102, 104) may be implemented with a script. For example, in one embodiment of the present invention, a script implementing the method of separating target data into data sets (e.g., 100) is shown in Appendix A. A script implementing the method of the parent process (e.g., 102) is shown in Appendix B, and a script implementing the method of the child process (e.g., 104) is shown in Appendix C.

In FIG. 1 target information is separated into mutually exclusive data sets as shown at 100. The target information is the information that will be transferred. The target information may be any type of data including voice, video, images, text, etc.

A parent process is then initiated as shown at 102. The parent process 102 launches child processes 104, which control the transfer of data. In one embodiment of the present invention, each mutually exclusive data set is communicated on an individual data stream. In another method of the present invention, several mutually exclusive data sets are communicated in a data stream. Several child processes 104, launched by the parent process 102, are then used to transfer the data sets in parallel and manage the data sets as they are transferred, as shown at 104. Managing the data sets includes sending the data to a destination and accommodating for errors. In addition, managing may include communicating the status of the overall process and logging information on the overall process.

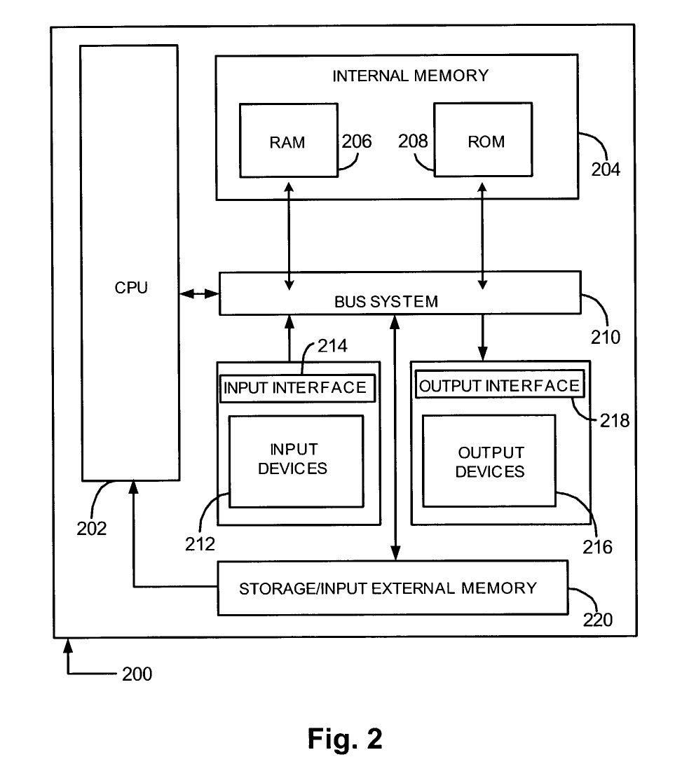

The method and apparatus of the present invention may be implemented using a multi-function computer. FIG. 2 is a block diagram of a multi-function computer 200 implementing the present invention. In FIG. 2 a central processing unit (CPU) 202 functions as the brains of the multi-function computer 200. Internal memory 204 is shown. The internal memory 204 includes short-term memory 206 and long-term memory 208. The short-term memory 206 may be Random Access Memory (RAM) or a memory cache used for staging information. The long-term memory 208 may be a Read Only Memory (ROM) or an alternative form of memory used for storing information. A bus system 210 is used by the CPU 202 to control the access and retrieval of information from short-term memory 206 and long-term memory 208.

Input devices such as joystick, keyboards, microphone or a mouse are shown as 212. The input devices 212 interface with the system through an input interface 214. Output devices such as a monitor, speakers, etc. are shown as 216. The output devices 216 interface with the multifunction computer 200 through an output interface 218. External memory such as a hard drive is shown as 220. The bus system 210 may communicate with output ports, which communicate information out of the multi-function computer 200. The information may be communicated from the bus system 210, through an interface (not shown) and across a local area network or across a wide area network.

The method and apparatus of the present invention may be implemented in a client-server architecture. In addition, the method and apparatus of the present invention may be implemented in a networked computer. When implemented in a networked computer, the method and apparatus of the present invention may be implemented in a local area network, a wide area network or across a distributed network.

Computer instructions such as computer scripts implementing the method and apparatus of the present invention may be stored in RAM 206, ROM 208 or in the external memory 220 (e.g., hard drive). In one embodiment of the present invention, computer scripts stored in the external memory 220, the RAM 206 or hard coded in the ROM 208 are run and instruct the CPU 202 to access target data stored in the external memory 220. The target data is read into RAM 206 sent across the bus system 210 and out an output port as parallel streams of data.

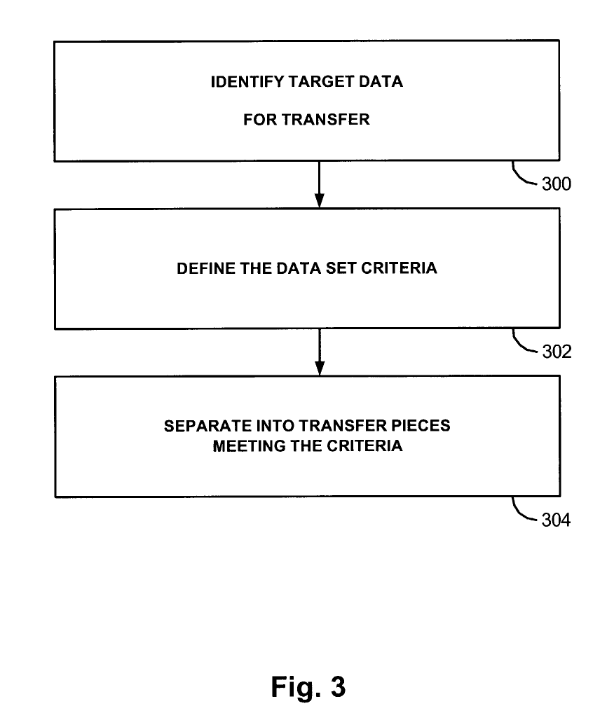

FIG. 3 displays a flow chart detailing one method of the present invention. In FIG. 3 the target of the transfer is identified as shown at 300. The target of the file transfer may include a large file, a multitude of files, a directory or a multitude of directories. Further, the target of the transfer 300 may include a directory including sub-directories or a multitude of directories including sub-directories.

Once the target of the transfer 300 is identified a criteria is established for separating the target data into mutually exclusive data sets as shown at 302. In one embodiment of the present invention, the criteria is defined such that a nearly equal (e.g., number of files, size of files) number of targets are formed for parallel transfer. For example, the criteria may be defined so that each parallel stream will communicate 1000 bytes of data. Therefore, the criteria is used to separate the target data into units that are 1000 bytes or less. Further, the criteria is defined so that the data is mutually exclusive. In another example, the data may be separated based on where the target data is located. As such, target data may be separated based on its position in a directory or sub-directory. The criteria may be defined so that the data sets do not have any interdependence. For example, the criteria may be defined so that files that are part of the same computer program are not separated. It should be appreciated that a large variety of criteria may be established and still remain within the scope of the present invention.

In one embodiment of the present invention, the data is separated into transfer files or directories. The transfer is performed between a client machine and a server machine. The client machine runs a process that creates separate parallel streams for transferring the target data. During the transfer process parallel data paths are established. The data sets are separated for transfer. Synchronization is performed with the server and the data is read into the system memory and transferred on the parallel data paths. During the transfer, the process is managed and error messages may be generated. For example, error messages warning that there is no destination directory identified, no destination server, no synchronization with the server, no source directory or no source server may be generated.

In the method of the present invention, target data is identified. For example, the target data may be a file or a directory of files. As shown in item 302, a criteria is defined to determine and create mutually exclusive data sets. As mentioned above, in one embodiment of the present invention, data sets are defined by the required size of the data set. Therefore, parallel streams with similar throughput may be achieved, since the data sets are selected to be of equal or similar size. For example, in standardized computer operating systems, data is organized into files and files may be organized into directories. The directories may include sub-directories. A script or utility may traverse the directory tree of a target directory and separate the directory into data sets of equal size or into a predefined number of data sets. For example, if a script or utility receives an input parameter of 100 bytes, as a maximum data set size, the script may traverse the directory tree starting at the lowest level of the directory and separate files and directories into data sets that are 100 bytes or less.

At step 304, a transfer target is separated into data sets that meet a pre-defined criteria. A script may be written to take a file and separate the file into equal data sets. For example, a file that is 100 megabytes may be separated into two files each with 50 megabytes. In an alternative, operating system tools may be used to separate the file into equal data sets for transfer. Therefore, a script or an operating system tool that receives the maximum file size of a file, as an input parameter, may be implemented. Using the maximum file size, a script may dissect the file into data sets that are equal to or less than the maximum file size. In another embodiment, a script or utility may receive as an input parameter, the number of resulting data sets. As such, the script or utility may separate the file into the number of data sets defined by the input parameter.

In one embodiment of the present invention, a script or utility is given the source of a file and the maximum size as input parameters. The script or utility may read the initial data into memory and then divide the initial data into data sets. Each data set is given a unique name or identifier. In addition, each data set is given a general suffix to identify the data sets as part of the initial data. After the transfer, the script or utility is run on the transmitting computer, but executed on the receiving computer. The script or utility recombines the data set into the initial data. The naming convention is used to recombine the data set on the receiving machine. For example, initial data entitled “test.123,” may be separated into data sets entitled “transfer1.data,” “transfer2.data” and “transfer3.data.” In the receiving computer, because of the naming convention “transfer1.data,” “transfer2.data” and “transfer3.data” may be recombined into the data set entitled “test.123.”

To separate the directories, standard operating systems include tools that may be used. For example, when using the UNIX operating system, UNIX utilities may be used to separate the data set. In the alternative, scripts may be written in a number of languages including the language of the operating system to implement utilities that separate directories or files into data sets.

In one method of the present invention, the data sets are separated into units equal to the number of parallel streams. For example, if 15 parallel streams are implemented, then 15 data sets will be implemented. In the alternative, the data sets may be separated into more sets than the number of parallel streams. In this scenario, the data sets may be queued and several data sets may be communicated on a single parallel stream.

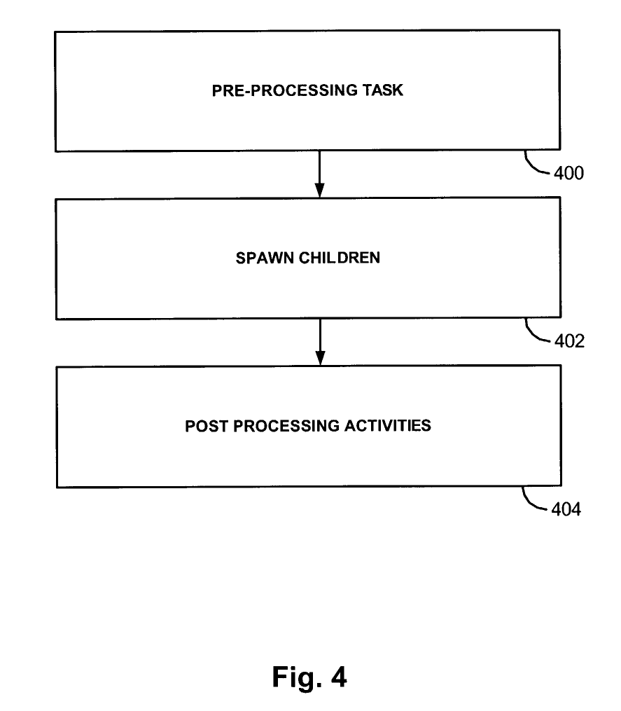

FIG. 4 displays a parent process implemented in the present invention. In the parent process, pre-processing task are accomplished as shown at 400, children are spawned as shown at 402 and post processing activities are conducted as shown at 404. Once the data sets have been identified and are ready for processing the parent process is initiated.

The pre-processing task as shown at 400 includes anything that is needed to prepare a receiving device to receive target data or to prepare the target data. Therefore, pre-processing includes all aspect of data set preparation or transfer preparation. For example, a test must be made to ensure that the user that runs the parent method has the ability to access the target data. Therefore, as part of pre-processing, a script may be launched to change ownership of the transfer data so that the user has access to the transfer data.

The parent process checks to see that the transfer data is ready and available for transfer. In addition, the parent process checks the destination for the transfer data. For example, in some cases directories are mirrored on the receiving computer. In other cases, files are transferred and stored in a different directory structure. Through the command line of an operating system, parameters may be passed to the parent process detailing the location of the target data and the location that the data should be delivered to in the receiving computer.

The parent process initiates several child processes as shown at 402. There is one child process for each parallel stream of data that is transferred. The parent process continually spawns child processes to transfer data sets. Before the transfer is completed, the parent process spawns additional child processes to transfer the remaining data sets.

The parent process does checking and reads information so that it can pass information onto each child process. For example, the parent method reads the instructions (e.g., input parameters) on each transfer and communicates this to the child process. The parent process reads the first target data for transfer and communicates this to the child process. The parent process also supplies the destination for the transfer to the child process.

The parent process accesses the transfer data, spawns a child process and then spawns another child process before completion of the first child process. The parent process performs this process for as many parallel transfer streams as needed. The parent process maintains the correct number of transfer streams by initiating and maintaining the correct number of child processes. In one embodiment of the present invention, there is a one-to-one correlation between the number of transfer streams, the number of child processes and the number of data sets. In another embodiment of the present invention, the number of transfer streams, the number of child processes and the number of data sets may not have a one-to-one correlation. For example, there may be a one-to-one correlation between the number of transfer streams and the number of child processes; however, there may be more data sets than transfer streams or child processes. In the scenario where there are more data sets than transfer streams, the parent method may send multiple data sets per transfer stream by sending several at a time or by sending one at a time in a round-robin fashion.

In one embodiment of the present invention, the parent method checks on the child during operation and when the transfer is complete, the parent method and the child communicate through a series of flags. In one implementation, a confirmation e-mail may be sent to an end user so that the end user knows that the parent and child processes have completed.

The parent process monitors the child process until the transfer is complete. In one embodiment of the present invention, the parent method is implemented as a script. The script is implemented as computer instructions that directs a multi-purpose computer to monitor a transfer for completion. During a transfer the computer instructions are loaded and run from computer memory. The parent monitors for completion of the transfer by staying resident in the memory, while the transfers are taking place and checking the status of the transfer at predetermined intervals. When the parent process receives a signal (e.g., flag) that the transfer is complete, the parent process performs post-processing and terminates.

In one embodiment of the present invention, the parent method forwards the data to a staging area, after which the data is combined in a target area. For example, the parent method does pre-transfer processing and then the parent method initiates children processes, which transfer the data sets from a source machine to a staging area in a destination machine. This implementation is usually done when there are security concerns or when a user does not want source information to directly alter the destination information. For example, in applications where revision control is important, combining data sets may corrupt the revision control. Therefore, it is important that the transfer data sets are not immediately combined in the destination directory. When staging is implemented, the data sets are positioned in the destination machine in a location (e.g., directory) that is easily combinable with the destination directory of the destination machine. The staging area is then synchronized with the target directory and the data is combined.

The parent method is also responsible for post processing activities as shown at 404. During post processing activities the parent method initiates a login and initiates commands on the source machine that performs operations on the destination machine. In other words, commands may be executed on the source machine and run on the destination machine. For example, operating system commands to create directories may be run on the source machine and create directories on the destination machine. In another example, if a user is moving data from one machine to another, it is common that the owner of the data on the source machine is different than the owner of the data on the destination machine. As a result, during post processing activities 404, the parent method may set ownership, set permissions for data and/or may re-index data by executing commands on the source machine that perform functions on the destination machine.

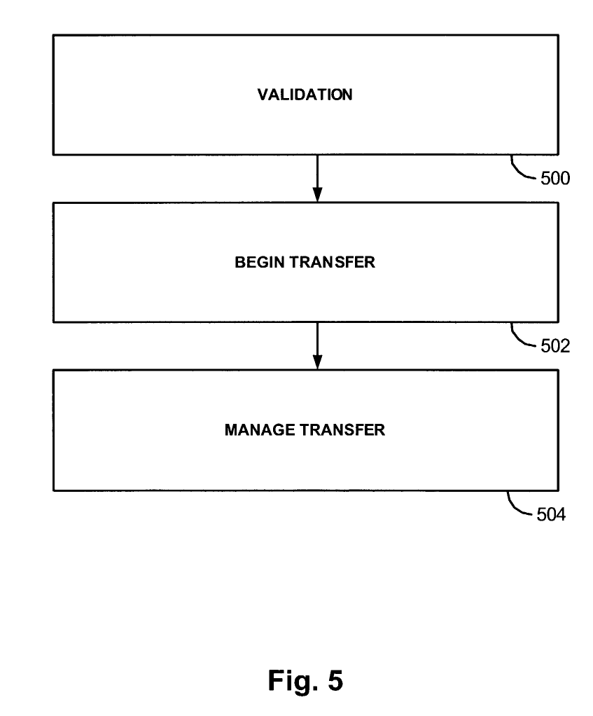

A child process is detailed in FIG. 5. As shown in FIG. 5, the child process performs validation 500, begins the transfer 502 and manages the transfer 504. The child process opens a port on the destination machine and creates a communication process using TCP/IP based utilities. Each child process opens a port on the destination machine.

The child process does validation as shown at 500. During validation 500, the child process ensures that there is source data for transfer and ensures that the destination machine can be reached. The child process then begins a transfer as shown at 502. The transfer depends on widely used TCP/IP utilities such as The Remote Copy Protocol (RCP). The Remote Copy ProtocolRCP runs in a standard operating system environment such as the UNIX operating system environment. The Remote Copy Protocol (RCP) enables users to execute commands on remote systems. This tool/utility uses Transmission Control Protocol (TCP) as the transport protocol, and listens for requests at TCP port 514.

A number of different methodologies may be implemented to manage the transfer (e.g., 504 of FIG. 5). In one method, two computers, A and B, plan to transfer information. Computer A stores data set A and has access to file/directory A and computer B stores data set B and has access to file/directory B. In addition, data sets A and B are different. In one method of the present invention, the child process manages the transfer as shown in 504 by splitting file/directory B into a series of mutually exclusive data sets (e.g., data set B) of size X. For each data set, computer B performs error control by calculating at least one checksum. Computer B then sends these checksums to computer A. Computer A, searches through file/directory A to find all the data sets (e.g., data set A) of size X that have the same checksum as data set B. Computer A sends Computer B a sequence of instructions for constructing a copy of file/directory A. Each instruction is either a reference to a data set of B or a data set. Data set A is sent for the portions of data set A, which did not match data set B. The end result is that computer B gets a copy of data set A, but only the portions of data set A that are not found in computer B.

In another embodiment of the present invention, the child process may also perform tunneling. For example, each child process can perform tunneling by initiating a connection that is encrypted and then communicating encrypted information between two endpoints, using TCP/IP utilities.

In yet another embodiment, network computers may be represented in a Graphical User Interface (GUI) and information may be dragged and dropped between two machines. When this is performed, the operating system utilities and TCP/IP utilities identified above are used to manage the connections and the transfer of data. However, the operating system utilities and TCP/IP utilities are invoked by manipulation of the GUI.

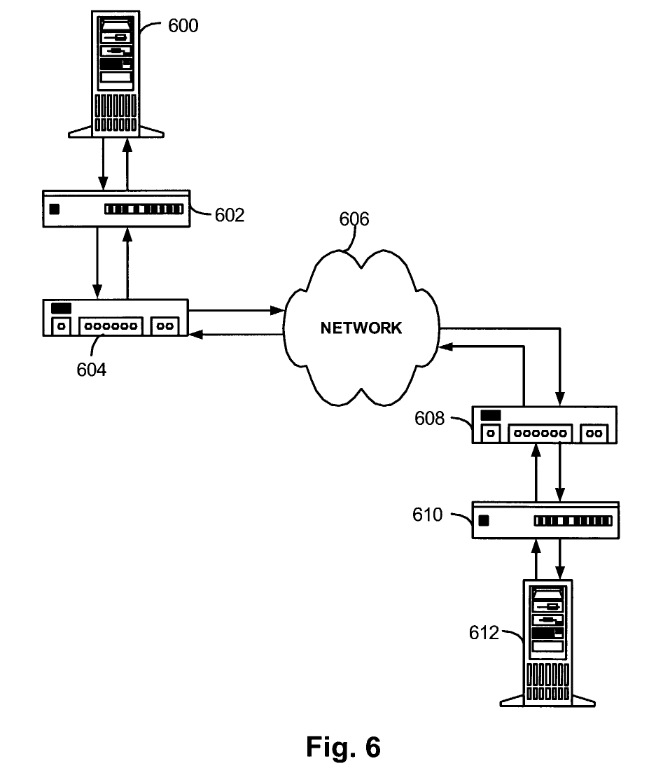

FIG. 6 displays one embodiment of the present invention. In FIG. 6 a source machine 600 includes a number of files or a large file for transfer to a destination machine 612. The source machine 600 transmits parallel streams of information through a switch 602, a router 604 and across a network 606. Parallel streams of data are then communicated across router 608 and switch 610 to the destination machine 612. In one embodiment of the present invention, the routers 604 and 608 have static routing to facilitate the transfer of data as parallel streams of data.

Thus, the present invention has been described herein with reference to a particular embodiment for a particular application. Those having ordinary skill in the art and access to the present teachings will recognize additional modifications, applications and embodiments within the scope thereof.

It is, therefore, intended by the appended claims to cover any and all such applications, modifications and embodiments within the scope of the present invention.

[image]

[image]

[image]

[image]

[image]

[image]

[image]

[image]

[image]

[image]

What is claimed is:

1. A method of transferring data comprising the steps of:
defining a first dataset and a second dataset using operating system tools, wherein the first data set is mutually exclusive from the second data set;
initiating a parent process; and
initiating a first child process in response to the parent process and initiating a second child process in response to the parent process, where the first child process communicates the first dataset by using Transmission Control Protocol utilities and the second child process communicates the second dataset in parallel with the first data set by using the Transmission Control Protocol utilities.

2. A method of transferring data as set forth in claim 1, wherein the second child process is initiated before the completion of the first child process.

3. A method of transferring data as set forth in claim 1, wherein the step of defining a first data set further comprises the steps of identifying target data for transfer, defining the first data set criteria and separating the target data into the first data set in response to the first data set criteria.

4. A method of transferring data as set forth in claim 1, wherein the step of initiating the parent process further comprises the steps of performing pre-processing task, spawning children processes and performing post processing task.

5. A method of transferring data as set forth in claim 1, wherein the step of initiating the child process further comprises the steps of performing validation on the first data set and on the second data set, beginning transfers of the first data set and the second data set and managing the transfer of the first data set and the second data set.

6. A method of transferring data as set forth in claim 1, wherein the second child process is initiated before completion of the first child process.

7. A system comprising:
means for defining a first dataset and a second dataset using operating system tools, wherein the first data set is mutually exclusive from the second data set;
means for initiating a parent process; and
means for initiating a first child process in response to the parent process and initiating a second child process in response to the parent process, where the first child process communicates the first dataset using Transmission Control Protocol utilities and the second child process communicates the second dataset in parallel with the first data set using the Transmission Control Protocol utilities.

8. A method of transferring data comprising the steps of:
defining a plurality of mutually exclusive data sets using operating system tools;
initiating a parent process; and
initiating a plurality of child processes in response to the parent process where each of the plurality of child processes accesses one of the plurality of mutually exclusive data sets and communicates each of the plurality of mutually exclusive data sets in parallel by using Transmission Control Protocol utilities.

9. A computer product comprising:
a computer useable medium and computer readable instructions embodied on the computer readable medium for causing a computer to transfer data in parallel streams, the computer readable instructions causing the computer to,
define a plurality of mutually exclusive data sets using operating system tools;
initiate a parent process; and
initiate a plurality of child processes in response to the parent process where each of the plurality of child processes accesses one of the plurality of mutually exclusive data sets and communicates each of the plurality of mutually exclusive data sets in parallel by using Transmission Control Protocol utilities.
